(19) United States
(12) Patent Application Publication
(10) Pub. No.: US 2022/0404900 A1
(43) Pub. Date: Dec. 22, 2022

(54) SYSTEM AND METHOD OF PREDICTING A MOOD OF A USER BASED ON TYPING INPUT

(71) Applicant: TYPINGDNA INC., Brooklyn, NY (US)

(72) Inventor: Raul-Laviniu Popa, Brooklyn, NY (US)

(21) Appl. No.: 17/843,361

(22) Filed: Jun. 17, 2022

Related U.S. Application Data
(60) Provisional application No. 63/212,935, filed on Jun. 21, 2021.

(51) Int. Cl. G06F 3/01; G06F 11/34

(52) U.S. Cl. CPC G06F 3/011; G06F 11/3438; G06F 2203/011

(57) ABSTRACT

Disclosed is a system and method for using typing input to predict a mood of a user that is typing the input. An example method includes receiving typing input provided by a user on a keyboard to yield typing input, evaluating, via a prediction module, the typing input to classify the typing input to yield an evaluation and, based on the evaluation, outputting a mood of the user. The prediction module includes a machine learning algorithm that using timing characteristics between key presses associated with the typing input to predict a mood of the user.

### PRIORITY INFORMATION

The present application claims the benefit of U.S. Patent Provisional Application No. 63/212,935, filed Jun. 21, 2022, the contents of which is incorporated herein in its entirety.

### TECHNICAL FIELD

The present disclosure relates to machine learning algorithms and more specifically to a machine learning algorithm that evaluates typing characteristics of the user as a user types on a keyboard and predicts a mood of the user based on the typing characteristics.

### BACKGROUND

Efforts have been made to determine a mood of a user in a certain circumstance. For example, customer support services often will receive telephone calls from users seeking help with the product. In some cases, such users can be angry with the product. Efforts have been made to evaluate the speech of the user to determine whether they are in an angry, happy, frustrated, or neutral mood. Such information can be helpful in seeking to assist the person resolve the problem.

However, in some cases, speech data is not available and it becomes difficult to evaluate the mood of a person with whom a computer system or another person is interacting.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates computer system as an aspect of this disclosure; and

FIG. 2 illustrates a method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### DESCRIPTION OF EXAMPLE EMBODIMENTS

Disclosed is a system and method that addresses the issue outlined above. The following disclosure introduces a new approach for predicting a mood of the user. The new approach involves using typing input or typing characteristics associated with how a user is typing on a keyboard to predict or determine a mood of the user.

An example method includes receiving typing input provided by a user on a keyboard to yield typing input, evaluating, via a prediction module, the typing input to classify the typing input to yield an evaluation and, based on the evaluation, outputting a mood of the user. The prediction module includes a machine learning algorithm that using timing characteristics between key presses associated with the typing input to predict a mood of the user.

### DETAILED DESCRIPTION

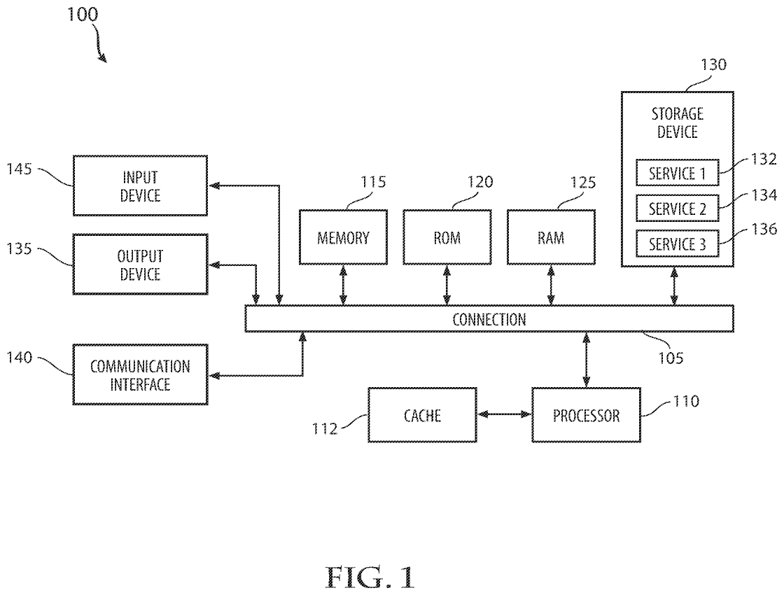

To address the issues raised above, the following disclosure provides a new approach to determining the mood or other characteristics of a user of a computing device as shown in FIG. 1. FIG. 1 illustrates an example computing system architecture of a system 100, which can be used to process data operations and requests, store data content and/or metadata, and perform other computing operations. The system 100 can be used as one of the plurality of computer servers 202, or could provide information about various components which can be part of an authorized user device 208 (or any of the user devices). In this example, the components of the system 100 are in electrical communication with each other using a connection 105, such as a bus. The system 100 includes a processing unit (CPU or processor) 110 and a connection 105 that couples various system components including a memory 115, such as read only memory (ROM) 120 and random access memory (RAM) 125, to the processor 110. The system 100 can include a cache of high-speed memory connected directly with, in close proximity to, or integrated as part of the processor 110. The memory 115, RAM 125, ROM 120 or any other memory device can represent the computer storage device which stores data or files within the system 200 and which are available for use across one or more of the platforms 218A-I as discussed above.

The system 100 can copy data from the memory 115 and/or the storage device 130 to cache 112 for quick access by the processor 110. In this way, the cache can provide a performance boost that avoids processor 110 delays while waiting for data. These and other modules can control or be configured to control the processor 110 to perform various actions. Other memory 115 may be available for use as well. The memory 115 can include multiple different types of memory with different performance characteristics. The processor 110 can include any general purpose processor and a hardware or software service, such as service 1 132, service 2 134, and service 3 136 stored in storage device 130, configured to control the processor 110 as well as a special-purpose processor where software instructions are incorporated into the actual processor design. The processor 110 may be a completely self-contained computing system, containing multiple cores or processors, a bus, memory controller, cache, etc. A multi-core processor may be symmetric or asymmetric.

The services 132, 134, 136 can represent a prediction module operating on the device 100 or can represent an application, such as a social media application or a messaging application, that has an embedded therein a prediction module that includes a machine learning algorithm or model that evaluates the typing characteristics or typing input and output so predicts a mood of the user.

To enable user interaction with the computing system 100, an input device 145 can represent any number of input mechanisms, such as a microphone for speech, a touch-sensitive screen and/or camera for gesture or graphical input, keyboard, mouse, motion input, speech and so forth. The input device can include a virtual keyboard on a touch-sensitive screen or a physical keyboard such as on a laptop or desktop computer. The keyboard can be any standard keyboard or it can also be developed as a specialized keyboard that can evaluate physical characteristic such as how hard a user presses on a key, or at what angle the user interacts with a key. Such data can be provided to the machine leaning models disclosed herein for evaluating the mood of the user.

An output device 135 can also be one or more of a number of output mechanisms known to those of skill in the art. In some instances, multimodal systems can enable a user to provide multiple types of input to communicate with the computing system 100. The communications interface 140 can generally govern and manage the user input and system output. There is no restriction on operating on any particular hardware arrangement and therefore the basic features here may easily be substituted for improved hardware or firmware arrangements as they are developed.

Storage device 130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 125, read only memory (ROM) 120, and hybrids thereof. The computer-readable medium may include memory or data storage media, such as non-volatile random access memory (NVRAM), electrically erasable programmable read-only memory (EEPROM), FLASH memory, magnetic or optical data storage media, and the like.

The storage device 130 can include services 132, 134, 136 for controlling the processor 110. Other hardware or software modules are contemplated. The storage device 130 can be connected to the connection 105. In one aspect, a hardware module that performs a particular function can include the software component stored in a computer-readable medium in connection with the necessary hardware components, such as the processor 110, connection 105, output device 135, and so forth, to carry out the function.

The concepts disclosed herein relate to an app/core technology that would predict user so-called “moods” based on their typing patterns. There are several main components. The first component is a typing pattern recorder and the second component is a prediction system. For example, service 1 132 can represent a typing pattern recorder that operates on the device or within an application and service 2 134 can represent the prediction system, prediction module or other machine learning algorithm or model that is trained to evaluate the typing characteristics or typing input and output the mood of the user.

A typing parameter recorder or typing biometrics recorder can be configured to record all the key events such as key press and key release and the key code, character, and actual key physical/virtual position of the key being typed, the time when these events occur. Any other data related to the typing activity can be reported as well including telemetry data on mobile such as accelerometer and gyroscope measurements. Whenever a user types any text in any application, the typing patterns are recorded. Furthermore, the recorder can also record typing that is performed on the website and a typing characteristics recorder to be configured on the device to evaluate the typing characteristics or can be configured as part of a website.

In one example, a desktop device (Mac/Win/Linux) can include a typing biometric recorder that would run in a background app, or directly in the app that wants to use this technology. On a mobile device (both iOS/Android), the typing pattern recorder can be constrained to be deployed as a custom keyboard app (can be the actual mood tracking app's official keyboard), an in-app keyboard (can be used strictly just in particular apps, or browser based apps) or from the device keyboard (such as Gboard or a physical external keyboard), through the limited abilities that each device/operating system has that allows the recording of such data in an active app directly.

As noted above, the system includes a prediction system, prediction module, machine learning model, machine learning algorithm, artificial intelligence algorithm, or other component that is trained to predict a mood of the user based on recorded typing patterns. Any of the systems or components can be trained on data that is labeled to predict the user moved. For example, a very tired user can be asked to type sentences using their mobile device. The timing that occurs between keys being pressed and other characteristics of the physical operation of typing on the mobile device for the tired person can be recorded and the data can be labeled for inclusion in the prediction system. An angry person can also be asked to type in sentences. Users with various moods can be asked to type on any kind of device such that the system can identify the timing characteristics, or other parameters associated with how it is the type characters on to the keyboard.

At any point, the system 100 can take any typing pattern recorded with the typing biometrics recorder and run it through the prediction system or machine learning algorithms trained to score different so-called “moods”. Moods can include one or more of emotions or sentiments, moods, needs, or other types of user characteristics such as their energy level or attention level. For example, emotions or sentiments can include neutral, happiness, sadness, angriness, surprise, disgust. Moods can include neutral, tired, stressed, focused, relaxed, excited, dizzy. Example needs include neutral, a need to eat, to hydrate, to sleep, to focus or to take a break. Other characteristics can include an energy level and an attention level.

By definition, all these moods are temporary characteristics of any given individual, characteristics that change with time, sometimes in a matter of minutes, and are not used to identify or authenticate the user per se. Thus, the prediction system might not only predict a current mood or other characteristic of the user but might also determine the trend. For example, if the user typing for 5 minutes, the system might determine that the person is becoming more angry over time, or more tired over time. The system might also determine that the person is actually becoming more alert over time or happier as they type. The system can determine such trends by comparing visible typing characteristics of the first time, such as when they begin typing, to a second time, such as 5 or 10 minutes later. The system can of course evaluate such characteristics at any time. Such as every 30 seconds, every minute, and presented graphically a trend as part of its output showing based on the data one or more of the trends associated with the mood or other characteristics of the user.

The machine learning algorithms behind can be of multiple types of algorithms typically used for classification, such as single-class or multi-class, with a binary or non-binary output. However, there is no specific type of machine learning algorithm or procedure. A combination of algorithms can be used as well. The system is trained to predict labels that were previously recorded and labeled in research.

The machine learning algorithms can also make multiple predictions for each mood and the different predictions can be done in parallel. Thus, there may not be just one mood that is predicted but there could be a value for each at all times. A changing value over time characterizing a level of how sad a person is can be output in parallel with a changing value over time of how angry the person is as well.

Simple or complex data engineering and data visualization can be used to compute various compound measurements before running the actual predictions. Such compound measurements can be any time measurements of combinations of any two or more keys. In one example, basic times such as DownKey1-UpKey2, DownKey2-UpKey2, DownKey1-DownKey2, DownKey1-UpKey2, UpKey1-DownKey2, UpKey1-UpKey2, etc. can be used as data for compound measurements. Compound measurements of the basic times can also include other data taken together, ranks, ratios, various differences, descriptive statistics, distribution statistics, or other more complex combinations/formulas that use the basic times. The compound measurements can also be related to three keys or four or more keys being pressed, and the timing between the presses.

Rank statistics can relate to an ascending or descending sorted order of the values of different key events, pair of keys, or other combos (Down1_Down2 for example) compared to previously stored ranks. These ranks can be learned and can provide significant value afterwards. Similar rank statistics usually means a global similarity in typing patterns, and for some typing characteristics in moods as well.

Ratios relate to measures in which two values (times, other compounded values) are divided one against the other. This works better than the sum/difference of them for some particular cases, for example a Flight/Dwell ratio.

The concept of various differences relates to a sum of absolute differences between values (sum of Euclidean distances), a Mahalanobis distance (or other distribution distances), etc. The Mahalanobis distance is a measure of the distance between a point P and a distribution D introduced by P. C. Mahalanobis in 1936. It is a multi-dimensional generalization of the idea of measuring how many standard deviations away P is from the mean of D. One way to characterize this is as “various distance measurements”. This refers to any difference/distance between values that should be similar since they are recorded on same type of event, and values that should be different. In one aspect, differences could be learned and part of a machine learning model.

Descriptive statistics relate to anything that describes the data or describes a Gaussian/normal distribution in statistical terms (examples would be average, mean, median, standard deviation, max, min, percentiles, etc.). One may also look at similar pairs of keys in terms of times, or vertical and horizontal travel on the keyboard. For example, “JI” and “KO” on a standard English keyboard layout has a similar traveled distance, in the same direction, and usually performed with right hand. For the multiple pair of keys that have similar typing behavior, the system may compute descriptive statistics only true for that particular distribution set of pairs. Ratios and other distances between these distributions can also be computed and can help in predicting mood, among other things including authentication.

Other compound measurements can relate to an immense set of possible compound measurements, including convolutions, mixture models, etc. These don't necessarily need to be produced/calculated, but they can improve results, sometimes significantly as these are more abstract features, and usually are more explainable. For example, it is known that a higher energy level usually comes with faster average seek times (Down1_Down2) than the user's baseline seek time (measurable on individual key pairs but also on average on many keys). The more tired a person is, the time to type “NU” pair will be slower than “UN” (same keys, opposite direction), therefore, the ratio between any two vertically-placed keys could help in depicting tiredness.

Stress, for example, is highly correlated with inconsistency in typing, which is often seen in longer standard deviations. A somewhat opposite trend can be seen for attention or focus moods. For all these to work well, most of the time a comparison against the user baseline is important (but not always necessary) as it can increase accuracy. Here is one example way in which this can work. First, the system computes the compound measurements+statistical data, and second, the system uses them as features to learn the moods in machine learning models, including deep learning models.

The machine learning models are typically trained separately and deployed already trained and they don't typically depend on the user's input/typing pattern. The models can be deployed on the user device or can be offered via a network-based server the receive the typing input and processes the input to output the prediction of the mood of the user. In one example, a pre-processing component can be configured on a user device or as part of an application that performs the initial evaluation and compound measurements of the basic times associated with the typing input to a network-based server that performs the more compute intensive analysis or processing by the machine learning algorithm. These models can predict any typing pattern from any user. Alternatively, machine learning algorithms can take user's typing patterns in account to either adjust prediction, or to actually train or fine tune the machine learning algorithm. For example, the system might present an option in a graphical button or window for the user to identify their mood. Before typing, the user can click on a button to indicate that they are happy, sad or angry. Then, that information can be correlated with their typing characteristics to generate or further refine a machine learning algorithm for that person. In one aspect, a system can be implemented in which during a training phase, such options are presented to a user so that they quickly and easily identify their mood and then begin typing. As a model is trained on that data, the number of options presented could diminish over time until the model meets a certain threshold and no longer presents options to the user because its predictive capabilities are sufficiently successful. Transfer learning can be used too.

The output device 135 can display the results of the prediction system with respect to a classification or determination of the mood or other characteristic of the user. The predictions made can be stored, displayed raw, or initially adjusted, standardized, and/or normalized to be displayed in a range that is easier to read by any user. For example, any predicted values can be adjusted to fit the interval −50 to 50 for each mood, where a value of 0 would be considered normal level for that specific mood.

These predictions can be displayed per hour (or different groups of minutes/hours), per day, per day of week, per week, per month, on the last 7, 30 or 90 days, or any other interval. Optionally, the predictions can be compared to other users' predictions (typically on a server-based app). This method can be used, for example, to compare employee moods in different departments.

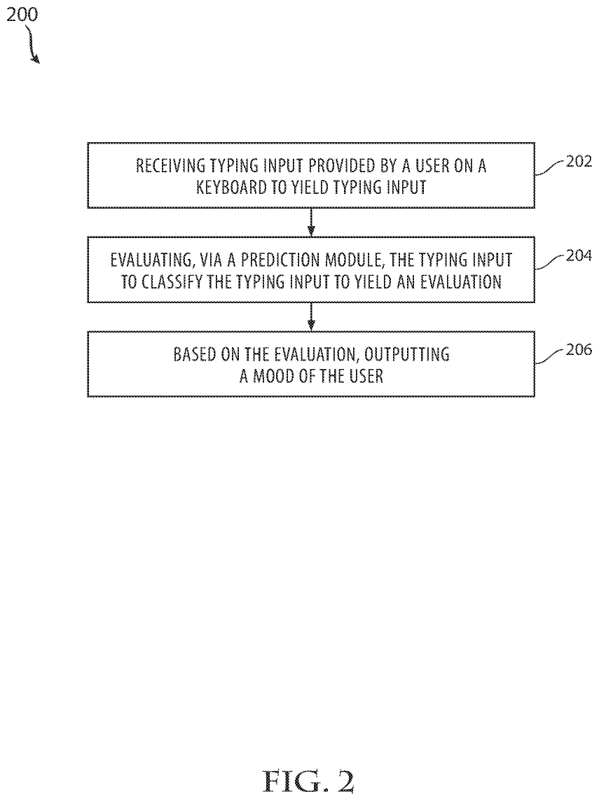

FIG. 2 illustrates a method embodiment. An example method 200 includes receiving typing input provided by a user on a keyboard to yield typing input (202), evaluating, via a prediction module, the typing input to classify the typing input to yield an evaluation (204) and, based on the evaluation, outputting a mood of the user (206). The prediction module can include a machine learning algorithm that using timing characteristics between key presses associated with the typing input to predict a mood of the user.

The prediction module can also be trained on other input data such as a user's temperature or facial recognition data which can identify whether a person's face is flushed or looks angry or happy. In addition, other data such as a user's motion in a seat, or how they move the mouse and at what speed can also have bearing on what the user's emotion or mood is. The system can be configured to receive such additional parallel data to the typing data and include that in the prediction module. Thus, if the typing input evaluation has a confidence level that might not be high enough to confirm a particular mood, the addition of a mouse movement, or a track pad movement analysis, might increase or decrease the confidence with respect to what the mood of the user is. Further additional data might be used as well. In some cases, the color on the wall in a room, or how light it is outside, or what the weather is, can also impact the user's mood. Such data can be included as well to the prediction module and can be weighted or evaluated with the typing data to determine the user's mood.

One type of input mentioned above is gesture input. This can be a gesture on a touch-sensitive screen of a computing device or can be a gesture of a user in the air with a hand. American sign language can be evaluated as gestures by a computing device. In some cases, typing in connection with or independent of a gesture can also indicate mood. How the user gestures might change based on their mood. Thus, another type of input to the prediction module can be a type of gesture and how the user makes that gesture. That data can be coordinated with other data such as the typing data to classify a mood of the user.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general-purpose computer, special purpose computer, or special purpose processing device to perform a certain function or group of functions. Portions of computer resources used can be accessible over a network. A computer system programmed with the algorithms disclosed herein or incorporated herein by reference are a special-purpose computer system according to Patent Office Guidance. The computer executable instructions may be, for example, binaries, intermediate format instructions such as assembly language, firmware, or source code.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. A device can include a computing device, a display, a microphone, and a video camera to carry out the video conferencing features described herein. As such, the device(s), when including these specific input/output components, are not generic computer processors but more specific hardware devices. Any features described as modules or components may be implemented together in an integrated logic device or separately as discrete but interoperable logic devices. If implemented in software, the techniques may be realized at least in part by a computer-readable data storage medium can include program code including instructions that, when executed, performs one or more of the methods, algorithms, and/or operations described above. The computer-readable data storage medium may form part of a computer program product, which may include packaging materials.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

Mood tracking based on typing biometrics

What is claimed is:

1. A system comprising:
a processor;
a keyboard; and
a computer-readable storage device, the computer-readable storage device storing instructions which, when executed by the processor, cause the processor to perform operations comprising:
receiving typing input provided by a user on the keyboard to yield typing input;
evaluating the typing input to classify the typing input to yield an evaluation; and
based on the evaluation, outputting a mood of the user.

2. The system of claim 1, further comprising:
a memory that stores the typing input.

3. The system of claim 1, wherein the typing input comprises typing patterns associated with the typing input.

4. The system of claim 1, further comprising:
a typing biometrics module that records that records key events associated with the typing input.

5. The system of claim 4, wherein the key events comprise one or more of a key press and a key release, a key code, character, an actual key physical/virtual position of the key being typed, a time when the typing input occurs, telemetry data gathered on a mobile device from an accelerometer measurement or a gyroscope measurement.

6. The system of claim 4, wherein the typing biometrics module runs in a background application or directly in an application that uses the typing biometrics module.

7. The system of claim 1, further comprising:
a prediction module configured to perform the operations of evaluating the typing input to classify the typing input to yield an evaluation and, based on the evaluation, outputting a mood of the user.

8. The system of claim 1, wherein the prediction module is configured to score or classify different moods of the user based on the evaluation.

9. The system of claim 8, wherein the moods comprise at least one or more of neutral, happy, sad, angry, surprised, disgusted, tired, stressed, focused, relaxed, excited, dizzy, hungry, thirsty, sleepy, ready for a break, a certain energy level and a certain attention level.

10. The system of claim 7, wherein the prediction module comprises a machine learning algorithm that has been trained to predict labels that were previously recorded and labeled.

11. The system of claim 1, wherein the computer-readable storage device, the computer-readable storage device stores additional instructions which, when executed by the processor, cause the processor to perform operations comprising:
computing a compound measurement on the typing input prior to evaluating the typing input.

12. The system of claim 11, wherein the compound measurement comprises a time measurement associated with a combination of any two or more keys interacted with by the user.

13. The system of claim 12, wherein the time measurement comprises a basis for data associated with ranks, ratios, various differences, descriptive statistics, distribution statistics, or other more complex combinations/formulas that use the time measurement.

14. The system of claim 12, wherein the time measurement comprises basic times comprising on or more of DownKey1-UpKey1, DownKey2-UpKey2, DownKey1-DownKey2, DownKey1-UpKey2, UpKey1-DownKey2 and UpKey1-UpKey2.

15. The system of claim 11, wherein the time measurement is used as part of the evaluating.

16. The system of claim 7, wherein the prediction module comprises one of a general prediction model for any user or a personal prediction module configured for the user.

17. The system of claim 1, wherein outputting a mood of the user comprises outputting one or more of raw data, adjusted data, standardized data, normalized data, graphical data, audio data, periodic data, and comparison data.

18. A method comprising:
receiving typing input provided by a user on a keyboard to yield typing input;
evaluating, via a prediction module, the typing input to classify the typing input to yield an evaluation; and
based on the evaluation, outputting a mood of the user.

19. The method of claim 18, wherein the prediction module comprises a machine learning algorithm that using timing characteristics between key presses associated with the typing input to predict a mood of the user.

20. The method of claim 18, further comprising outputting, based on the evaluation, multiple predictions for multiple moods in parallel.

21. The method of claim 18, further comprising outputting, based on the evaluation, a first prediction for a first mood of the user and a second prediction for a second mood of the user.

22. The method of claim 21, wherein the first prediction and the second prediction are calculated in parallel and/or calculated over time.
